(19) United States
(12) Patent Application Publication
(10) Pub. No.: US 2026/0246315 A1
(43) Pub. Date: Aug. 20, 2026

(54) STATOR, METHOD FOR PRODUCING A STATOR, FLUID GUIDE BODY, AND ELECTRIC MACHINE

(71) Applicant: Schaeffler Technologies AG & Co. KG, Herzogenaurach (DE)

(72) Inventors: Michael Marsetz, Ettlingen (DE); Wolfgang Haas, Bühl (DE); Stephan Penner, Bühl (DE)

(21) Appl. No.: 19/161,643

(22) PCT Filed: Feb. 1, 2024
(86) PCT No.: PCT/DE2024/100083

§ 371 Date: Sep. 2, 2025

(30) Foreign Application Priority Data
Mar. 2, 2023 (DE) 10 2023 105 136.9

(51) Int. Cl. H02K 1/16; H02K 1/20; H02K 3/50; H02K 11/33

(52) U.S. Cl. CPC H02K 1/16; H02K 1/20; H02K 3/50; H02K 11/33

(57) ABSTRACT

A stator includes a plurality of stator teeth, each stator tooth defining a respective stator groove located between adjacent stator teeth in the circumferential direction, extends in the radial direction, runs through the stator in the axial direction, and comprises two groove lateral walls and a groove base and into which an energizable winding is inserted. The winding exits the stator at a first end face and forms a first cylindrical winding head. A cooling fluid can flow through the stator from the first end face. The stator has a cylindrical fluid guide body through which the cooling fluid flows and partly surrounds the first winding head. A first conductor of the winding head has a first contacting section that extends out of the winding head in the axial direction and passes through a corresponding first electric contacting means.

### CROSS-REFERENCE TO RELATED APPLICATION

The present application is the U.S. National Phase of PCT Patent Application Number PCT/DE 2024/100083, filed on Feb. 1, 2024, which claims priority to German Patent Application Number 10 2023 105 136.9, filed Mar. 2, 2023, the entire disclosures of which are incorporated by reference herein.

### TECHNICAL FIELD

The present disclosure relates to a stator for an electric machine, in particular within a drive train of a motor vehicle, wherein the stator is designed in the form of a cylindrical ring with an inner diameter, in which a rotor with an outer diameter can be inserted, thereby forming a cylindrical air gap, and the stator has a plurality of stator teeth, each stator tooth defining a respective stator groove which is located between adjacent stator teeth in the circumferential direction, extends in the radial direction, runs through the stator in the axial direction, and comprises two groove lateral walls and a groove base, into which an energizable winding is inserted, said winding comprising a plurality of conductors, wherein the winding exits the stator at at least a first end face, thereby forming a first cylindrical winding head and wherein a cooling fluid can flow through the stator from the first end face. The disclosure furthermore relates to a method for producing a stator, a fluid guide body, and an electric machine.

### BACKGROUND

Electric motors are increasingly being used to drive motor vehicles to create alternatives to internal combustion engines that require fossil fuels. Significant efforts have already been made to improve the suitability of electric drives for everyday use and also to be able to offer users the driving comfort which they are accustomed to.

A detailed description of an electric drive can be found in an article in the German automotive magazine ATZ, volume 113, 05/2011, pages 360-365 by Erik Schneider, Frank Fickl, Bernd Cebulski and Jens Liebold with the title: Hochintegrativ und Flexibel Elektrische Antriebseinheit für E-Fahrzeuge [Highly Integrative and Flexible Electric Drive Unit for E-Vehicles]. This article describes a drive unit for an axle of a vehicle which comprises an electric motor that is arranged so as to be concentric and coaxial with respect to a bevel gear differential, a shiftable 2-speed planetary gear set being arranged in the drive train between the electric motor and the bevel gear differential and being likewise positioned to be coaxial with the electric motor and the bevel gear differential or spur gear differential. The drive unit is very compact and allows for a good compromise between gradability, acceleration and energy consumption due to the shiftable 2-speed planetary gear set. Such drive units are also referred to as e-axles or electrically operable drive train.

In addition to purely electrically operated drive trains, hybrid drive trains are also known. Such drive trains of a hybrid vehicle usually comprise a combination of an internal combustion engine and an electric motor, and enable, for example in urban areas, a purely electric mode of operation while at the same time permitting both sufficient range and availability, in particular when driving cross-country. In addition, drive can also be provided by the internal combustion engine and the electric motor at the same time in certain operating situations.

In the development of electric machines intended for e-axles or hybrid modules, there is a continuing need to increase their power densities, so the cooling of electric machines required for this is growing in importance. Owing to the necessary cooling capacities, hydraulic fluids such as cooling oils have become established in most concepts for the removal of heat from the thermally loaded regions of an electric machine.

Jacket cooling as well as winding head cooling are known, for example, from the prior art for cooling electric machines by means of hydraulic fluids. While jacket cooling transfers the heat generated at the outer surface of the stator laminated core into a cooling circuit, the heat transfer takes place in the case of the winding head cooling immediately at the conductors outside the stator laminated core in the region of the winding heads into the fluid.

Further improvements are provided by separate cooling channels, which are introduced both in the stator laminated core (see, for example, EP3157138 A1) and in the groove, in addition to the conductors (see, for example, Markus Schiefer: Indirekte Wicklungskühlung von hochausgenutzten permanenterregten Synchronmaschinen mit Zahnspulenwicklung [Indirect Winding Cooling of Highly Utilized Permanently Excited Synchronous Machines with Toothed Coil Winding], dissertation, Karlsruhe Institute of Technology (KIT), 2017).

Concepts are also known in which hydraulic fluid flows directly around the windings in order to increase the power density. Improved cooling with direct contact of the hydraulic fluid and conductor in the groove is already known per se from the prior art. For example, DE102015013018 A1 describes a solution for electric machines with a single-tooth winding, wherein the fluid flows directly around the windings, which are wound around the teeth.

Electric machines that have a hollow cylindrical stator, i.e. are designed as internal rotor machines, and that are configured for use as a traction drive of a motor vehicle often have a stator winding with a rectangular cross-section in order to achieve a high power density. In electric machines intended for driving motor vehicles, the stator windings are therefore typically designed as hairpin windings. In this case, for example, substantially U-shaped wire segments are introduced into the stator grooves from one end face of the stator and then shaped at an opposite end face of the stator and connected, for example, by welding.

### SUMMARY

The object of the disclosure is therefore to provide a stator for an electric machine which can provide a high power density and effective cooling and, in particular, can be mounted particularly easily and safely. It is also the object of the disclosure to provide an optimized electric machine and an optimized method for producing a stator. Furthermore, it is the object of the disclosure to realize an improved fluid guide body for a stator of an electric machine.

The object is achieved by a stator for an electric machine, in particular within a drive train of a motor vehicle, wherein the stator is designed in the form of a cylindrical ring with an inner diameter, in which a rotor with an outer diameter can be inserted, thereby forming a cylindrical air gap, and the stator has a plurality of stator teeth, each stator tooth defining a respective stator groove which is located between adjacent stator teeth in the circumferential direction, extends in the radial direction, runs through the stator in the axial direction, and comprises two groove lateral walls and a groove base, into which an energizable winding is inserted, said winding comprising a plurality of conductors, wherein the winding exits the stator at at least a first end face, thereby forming a first cylindrical winding head and wherein a cooling fluid can flow through the stator from the first end face, wherein the stator has a cylindrical fluid guide body through which the cooling fluid can flow and which at least partly surrounds the first winding head, wherein at least one first conductor of the winding head has a first contacting section that extends out of the winding head in the axial direction and at least partly passes through a corresponding first electric contacting means, which is arranged on the fluid guide body in an electrically contacting manner, wherein the first electric contacting means is coupled to a first electric connection means in an electrically conductive manner, by means of which an electric contacting can be established between the first conductor and an inverter energizing the winding via an outer side of the fluid guide body facing away from the cooling fluid.

This has the advantage that an electric contacting of a winding head of a stator can be provided, in which the wiring of an actively cooled stator can be transferred from a wet to a dry chamber in an assembly-friendly manner by axially placing the fluid guide body. This means that contacting between the winding and an inverter can be routed out of the oil chamber while ensuring oil tightness. The corresponding wiring elements, in particular the electric contacting means and the electric connection means, can be pre-assembled on the fluid guide body before it is mounted, which can further simplify manufacture and assembly. The contacting with the winding is therefore established when the fluid guide body is mounted opposite the winding head.

For example, welding a conductor to the corresponding contacting means creates the electrical contact and at the same time the oil tightness. Alternatively or additionally, the conductor can be connected to a contacting means by crimping and/or clamping.

Furthermore, it is possible for the electric connection means to be a busbar section with an opening, preferably a hole, through which the corresponding contact elements are fastened to the inverter, for example by additional screws and nuts. It is also possible for the electric connection means to have an internal thread in its opening so that the contact elements can be screwed directly to the inverter. It is also possible that a sleeve with an internal thread is pressed into the opening of the connection means. A particularly compact design can be achieved by positioning the internal thread axially offset towards the stator in the fluid guide body, so that it does not protrude from the base of the fluid guide body, for example.

The fluid guide body is preferably made of plastic. It may also be preferable for an electric contacting means and an associated electric connection means to be formed in one piece, in particular monolithically.

A winding with conductors can particularly preferably be embedded in the stator grooves of the stator according to the disclosure. A conductor is in particular an electrically conductive conductor with two conductor portions which run in parallel and comprise longitudinal extensions that are significantly larger than their diameters. In principle, the conductor portions can have any cross-sectional shape other than a circular shape. Rectangular cross-sectional shapes are preferred since these allow high packing densities and consequently high power densities to be achieved. Particularly preferably, a conductor is formed of copper. Preferably, a conductor is insulated. To insulate the conductors, for example, mica paper, which for mechanical reasons can be reinforced by a glass fabric carrier, can be wound in tape form around one or more stator windings, which are impregnated by means of a curing resin. In principle, it is also possible to use a curable lacquer layer without mica paper to insulate a conductor.

Most preferably, the winding is designed as a hairpin winding or wave winding. In this context, it is further preferred that the conductors are designed as hairpin conductors.

The stator according to the disclosure also has a stator body. The stator body can be made in one piece or in multiple pieces, in particular in a segmented manner. A one-piece stator body is characterized by the fact that the entire stator body is formed in one piece as viewed over the circumference. The stator body is usually formed from a multiplicity of stacked laminated electrical steel sheets, with each of the electrical steel sheets being closed to form a circular ring. A segmented stator body is characterized by the fact that it is constructed from individual stator segment parts. The stator body can be constructed from individual stator teeth or stator tooth groups, and each individual stator tooth or each individual stator tooth group can be formed from a multiplicity of stacked laminated electrical steel sheets, with each of the electrical sheets being designed as a stator segment lamination part.

The stator body is preferably formed from one or more stator laminated cores. A stator laminated core is understood to mean a plurality of laminated individual laminations or stator sheets, which are generally made from electrical steel sheets and are layered and packed one on top of the other to form a stack or what is referred to as a stator laminated core. The individual laminations can then remain held together in the laminated core by adhesive bonding, welding or screwing.

The stator teeth of the stator are preferably formed in the stator body. Stator teeth are components of the stator body which are designed as circumferentially spaced, tooth-like parts of the stator body that are directed radially inward, with an air gap for the magnetic field being formed between the free ends of the stator teeth and a rotor body. The gap between the rotor and the stator is referred to as the air gap. In a radial flux machine, this is a substantially annular gap with a radial width that corresponds to the distance between the rotor body and the stator body.

In particular, the stator can be provided for use in an electric machine within a drive train of a motor vehicle. The electric machine is intended in particular for use within a drive train of a hybrid or fully electrically driven motor vehicle. In particular, the electric machine is dimensioned such that vehicle speeds of more than 50 km/h, preferably more than 80 km/h, and in particular more than 100 km/h can be achieved. The electric machine particularly preferably has an output of more than 30 kW, preferably more than 50 kW and in particular more than 70 kW. Furthermore, it is preferred that the electric machine provides rotational speeds greater than 5,000 rpm, particularly preferably greater than 10,000 rpm, very particularly preferably greater than 12,500 rpm.

According to an advantageous embodiment of the disclosure, the plurality, preferably all, of the electrical conductors have a substantially rectangular contour in cross-section. The advantage of this embodiment is that electrical conductors that are generally available as standard can be used to form the stator winding, which is particularly favorable in terms of the manufacturing costs of the stator.

The function of the cooling fluid in the stator according to the disclosure is to dissipate heat as efficiently as possible from regions of the stator that are heating up and to prevent these regions from overheating. In addition to this main task, the cooling fluid can in particular also provide lubrication and corrosion protection for the moving parts and/or the metal surfaces of the cooling system of the stator or the electric machine. In addition, it can, in particular, also remove contaminants (for example as caused by abrasion), water and air. The cooling fluid is preferably a liquid. The cooling fluid can in particular be an oil. In principle, however, it is also conceivable to use aqueous cooling fluids, for example also emulsions, such as water-glycol mixtures.

The cooling fluid of the stator can be connected to a hydraulic cooling system with a hydraulic cooling circuit. Such a hydraulic cooling system is used to dissipate the heat generated by electrical losses within an electric machine. Such a cooling system can have cooling channels within the rotor (rotor cooling channel) and/or stator (stator cooling channel), in particular also a flow through the stator grooves, through which a corresponding cooling fluid is guided for the purpose of removing the heat.

The cooling fluid can particularly preferably be pumped through the hydraulic circuit by means of a pump. In principle, it is conceivable to design a plurality of hydraulic circuits in order to cool the electric machine. In this case, it is highly preferred that the cooling channels of the stator are connected to a hydraulic cooling circuit or to various cooling circuits of the cooling system. In particular, by connecting to several cooling circuits, it is possible to provide more precise cooling, since, for example, the temperature of the cooling fluid when entering the cooling channels of the stator, the flow velocity of the cooling fluid or even the type of cooling fluid (oil, emulsion) can be adjusted.

The stator grooves are preferably closed by a groove closure means so that the cooling fluid cannot flow from the stator grooves into the air gap between the rotor and the stator. Particularly preferably, the groove closure means is a groove closure wedge.

For the purposes of this application, motor vehicles are land vehicles that are moved by machine power without being bound to railroad tracks. A motor vehicle can be selected, for example, from the group of passenger cars, trucks, small motorcycles, light motor vehicles, motorcycles, motor buses/coaches or tractors.

Further advantageous embodiments of the disclosure are specified in the dependent claims. The features listed individually in the dependent claims can be combined with one another in a technologically meaningful manner and can define further embodiments of the disclosure. In addition, the features indicated in the claims are specified and explained in more detail in the description, wherein further preferred embodiments of the disclosure are shown.

According to an advantageous embodiment of the disclosure, it can be provided that a second conductor of the winding head has a second contacting section that extends out of the winding head in the axial direction and at least partly passes through a corresponding second electric contacting means, which is arranged on the fluid guide body in an electrically contacting manner, wherein the second electric contacting means is coupled to a second electric connection means in an electrically conductive manner, by means of which an electric contacting can be established between the second conductor and an inverter energizing the winding via an outer side of the fluid guide body facing away from the cooling fluid and/or a third conductor of the winding head has a third contacting section that extends out of the winding head in the axial direction and at least partly passes through a corresponding third electric contacting means, which is arranged on the fluid guide body in an electrically contacting manner, wherein the third electric contacting means is coupled to a third electric connection means in an electrically conductive manner, by means of which an electric contacting can be established between the third conductor and an inverter energizing the winding via an outer side of the fluid guide body facing away from the cooling fluid. The advantage of this embodiment is that it allows multiphase, in particular three-phase, energization of the winding of the stator with a correspondingly easy-to-install electrical contacting by axial placement of the fluid guide body.

According to a further preferred further development of the disclosure, it can also be provided that the first electric contacting means and/or the second electric contacting means and/or the third electric contacting means each has/have a material connection with the fluid guide body, in particular a bonding or overmolding.

On the one hand, a defined positioning of a contacting means to the fluid guide body can be achieved and furthermore a sealing of the contacting means to the fluid guide body. A contacting means can be overmolded, for example, during an injection molding process to form the fluid guide body.

In principle, it would also be possible for the first electric contacting means and/or the second electric contacting means and/or the third electric contacting means to be attached to each other by means of a force-fit and/or form-fit connection. In particular, the first electric contacting means and/or the second electric contacting means and/or the third electric contacting means can each be connected to the fluid guide body by means of a press connection. It would also be possible for the first electric contacting means and/or the second electric contacting means and/or the third electric contacting means to each have an external thread, so that a contacting means is locked by a nut and can be fixed to the fluid guide body.

It is also advantageous that the contacting means are substantially identical. In this context, it is also preferable that the electric connection means are also designed identically. The electric connection means can be formed in one piece, in particular monolithically, with a contacting means or attached to a contacting means as a separate component.

Furthermore, according to an equally advantageous embodiment of the disclosure, it can be provided that the first electric contacting means and/or the second electric contacting means and/or the third electric connection means each has/have a cone-like insertion section that widens in the direction of the first winding head, so that the electrical conductors to be connected can be threaded into the electrical contacting areas provided during assembly of the fluid guide body and, furthermore, a certain tolerance compensation can be provided during assembly, which can also facilitate this.

According to a further particularly preferred embodiment of the disclosure, it can be provided that the first electric contacting means has a first opening through which the first conductor passes and which protrudes from the first opening of the first electric contacting means, and/or the second electric contacting means has a second opening which is penetrated by the second conductor and protrudes from the second opening of the second electric contacting means and/or the third electric contacting means has a third opening which is penetrated by the third conductor and protrudes from the third opening of the third electric contacting means. This makes it possible, in particular, to visually check that the fluid guide body has been successfully and completely placed on the winding head. Furthermore, the conductor sections protruding from an opening can be welded to the contacting means particularly easily, whereby a fluid-tight connection can be formed between the corresponding conductor and the contacting means at the same time.

Furthermore, the disclosure can also be further developed in such a way that the cylindrical fluid guide body has an annular base and an inner shell extending axially out of the base and an outer shell extending axially out of the base, wherein the inner shell has an inner diameter which is greater than or equal to the outer diameter of the rotor. This has the advantage that the rotor can be realized in a particularly simple way by axial insertion into the stator, wherein the stator is then already fully assembled and provided with a fluidic cooling system. This means that the fluid guide body can first be connected to a connection body of the stator, thereby assembling the fluid cooling system and the electrical connection of the winding head of the stator. The rotor can then be inserted axially into the ready-to-operate stator, which simplifies assembly and production logistics.

The connection between the fluid guide body and the connection body is particularly preferably oil-tight, for example by using appropriate seals such as O-rings or by bonding. In order to achieve a particularly good bond, a connection groove can preferably provide defined adhesive gaps as an adhesive joint, for example in a V-shape. The adhesive is applied as a continuous bead around the entire circumference in the base of a connection groove. This ensures that adhesive is present over the entire circumference. During assembly of the fluid-guiding element, the adhesive is then pressed into the connection groove over the entire circumference by means of connecting collars that engage in the connection groove, thus achieving a closed adhesive ring in a connection groove so that an oil-tight bond can be achieved. In particular, this can be used to define a dry space inside the stator.

Furthermore, the fluid guide body can preferably be positioned precisely in the circumferential direction relative to the stator and/or connection body by suitable centering means, so that, for example, a fluid connection of the fluid guide body can meet a corresponding mating bore and/or the corresponding conductors of the winding head in the corresponding electric contacting means without further tolerance compensation.

The winding inserted in the stator grooves preferably emerges from the stator, forming a winding head on each of the two end faces of the stator, wherein at least one connection body is molded into or onto the stator body of the stator. The advantage of this is that a number of different functions can be provided in a component produced by injection molding using an injection-molded connection body. These functions of the connection body can, for example, be selected from the group of fixing functions, locking functions, insulation functions and/or sealing functions.

In an equally preferred embodiment of the disclosure, it can also be provided that the first electric contacting means and/or the second electric contacting means and/or the third electric contacting means are/is arranged in each case on the base of the cylindrical fluid guide body. This makes it possible to realize a particularly easy-to-install connection between a corresponding conductor of the winding head and a contacting means, which is formed by pushing the fluid guide body axially onto the winding head. Furthermore, the respective electric connection means can also be connected via the base of the fluid guide body for easy installation.

The object of the disclosure is also achieved by a method for producing a stator for an electric machine, in particular within a drive train of a motor vehicle, comprising the following steps:
providing a cylindrical stator with an inner diameter, in which a rotor with an outer diameter can be inserted, thereby forming a cylindrical air gap, and the stator has a plurality of stator teeth, each stator tooth defining a respective stator groove which is located between adjacent stator teeth in the circumferential direction, extends in the radial direction, runs through the stator in the axial direction, and comprises two groove lateral walls and a groove base, into which an energizable winding is inserted, said winding comprising a plurality of conductors, wherein the winding exits the stator at at least a first end face, thereby forming a first cylindrical winding head and wherein a cooling fluid can flow through the stator from the first end face, wherein at least a first conductor of the first winding head has a first contacting section that extends out of the winding head in the axial direction,
providing a cylindrical fluid guide body through which the cooling fluid can flow, wherein the first winding head can be at least partly surrounded by the fluid guide body,
arranging a first electric contacting means on the fluid guide body, through which the first contacting section of the first electrical conductor can at least partly pass in an electrically contacting manner,
arranging the fluid guide body on the first winding head, thereby forming the electric contacting of the first contacting section with the first electric contacting means.

The advantage of this is that the fluid guide body can be pre-assembled with the electric contacting means as an assembly and the corresponding conductors of the winding head can then be electrically connected by sliding them axially onto the winding head for easy installation.

The object of the disclosure is further achieved by a fluid guide body for a stator of an electric machine, wherein the fluid guide body is designed to be cylindrical and through which cooling fluid can flow, wherein a first electric contacting means arranged on the fluid guide body can be electrically contacted at least partly by a first conductor of the winding head and is coupled to a first electrical connection means in an electrically conductive manner, by means of which an electric contacting can be established between the first conductor and an inverter energizing the winding via an outer side of the fluid guide body facing away from the cooling fluid.

Finally, the object of the can also be achieved by an electric machine, in particular within a drive train of a motor vehicle, characterized in that the electric machine comprises a stator according to one of claims 1-7.

The disclosure is explained in more detail below with reference to figures without limiting the general concept of the disclosure.

### BRIEF DESCRIPTION OF THE DRAWINGS

### In the Figures:

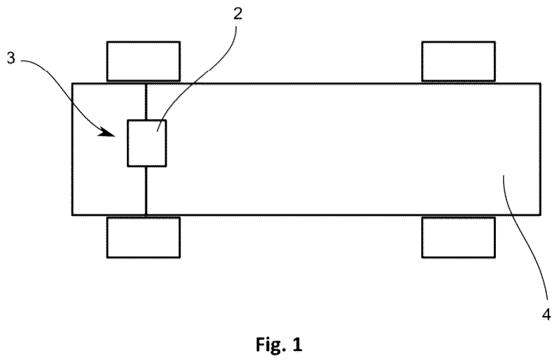

FIG. 1 shows a motor vehicle comprising an electric axle drive train in a schematic representation,

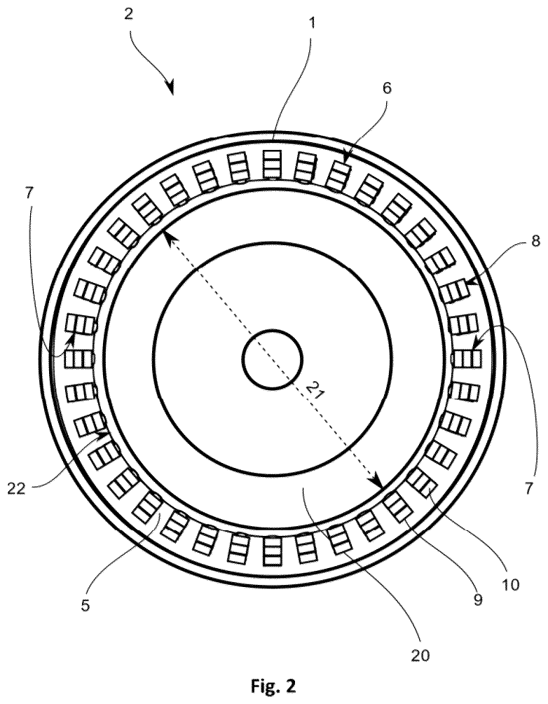

FIG. 2 shows an electric machine in a cross-sectional view,

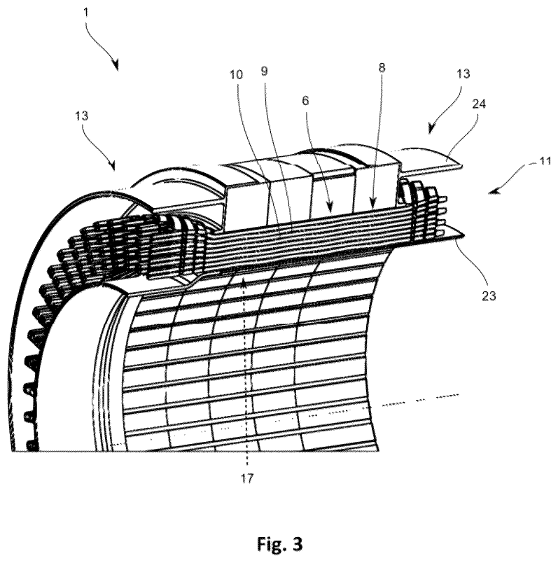

FIG. 3 shows a stator in a perspective axial sectional view,

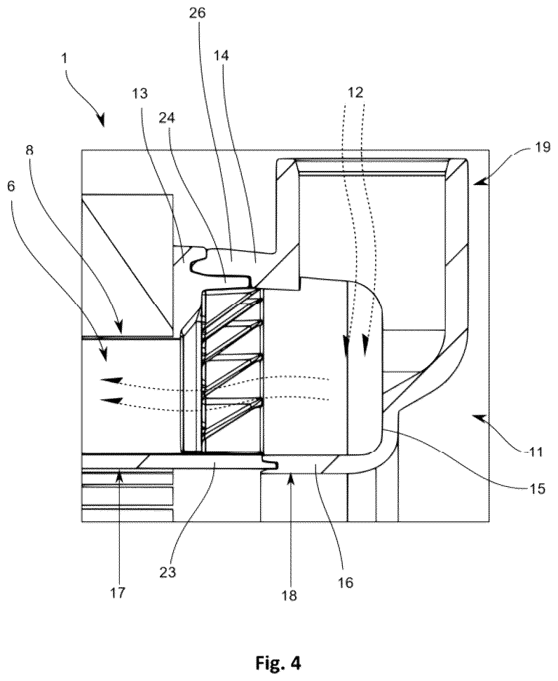

FIG. 4 shows a first detailed view of an electric machine with a bonded fluid guide body in an axial sectional view,

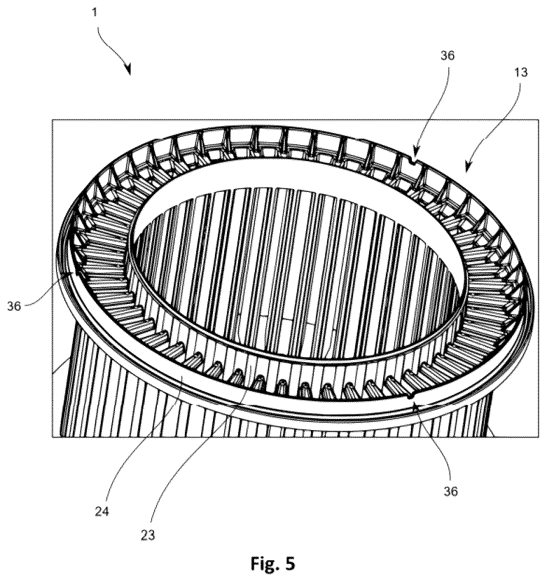

FIG. 5 shows a perspective view of the stator body with a connection body,

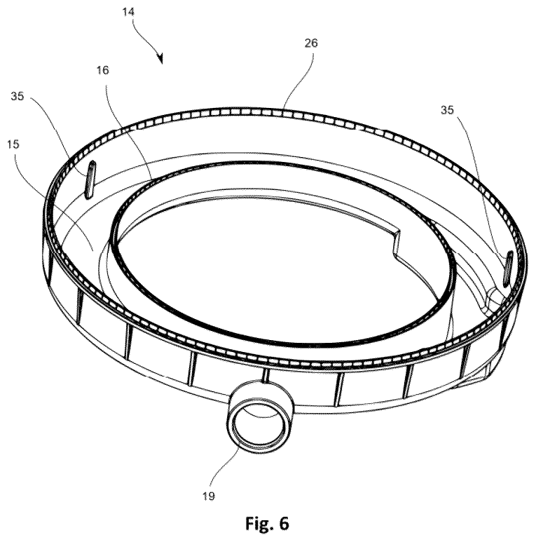

FIG. 6 shows a perspective view of the fluid guide body,

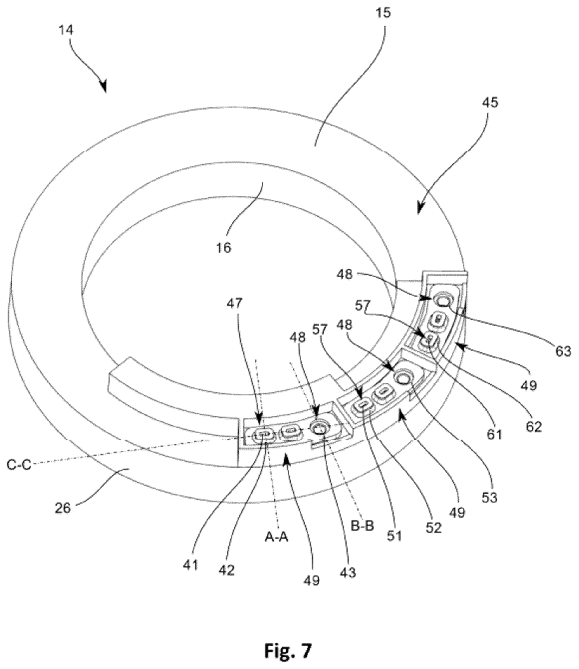

FIG. 7 shows a first embodiment of a fluid guide body in a perspective view,

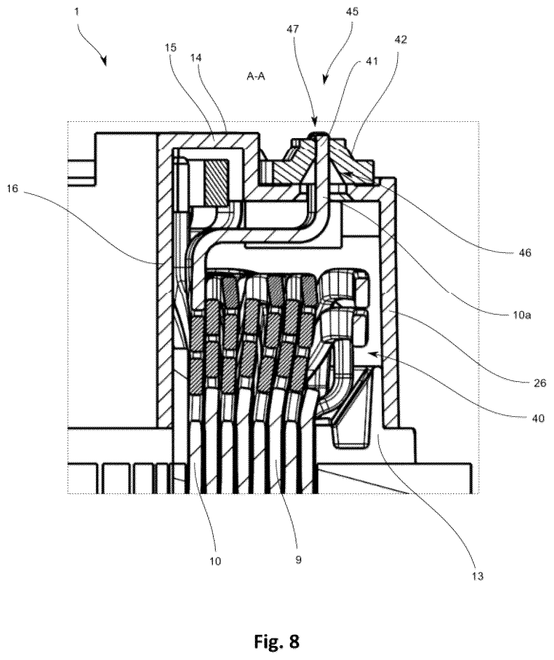

FIG. 8 shows a first embodiment of a fluid guide body in a first radial sectional view,

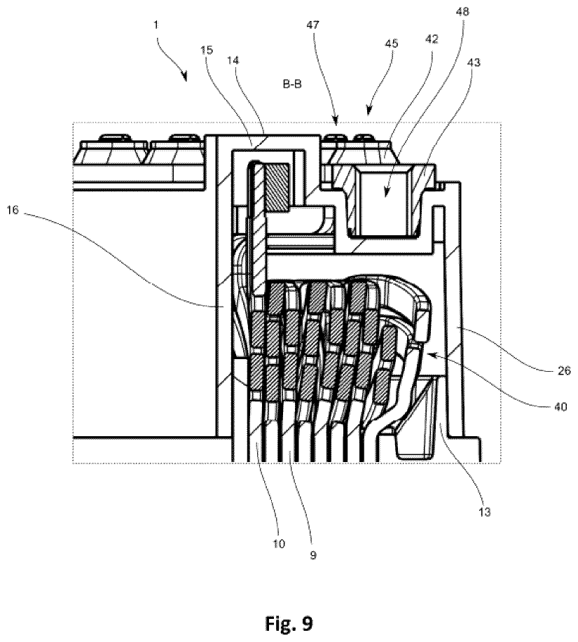

FIG. 9 shows a first embodiment of a fluid guide body in a second radial sectional view,

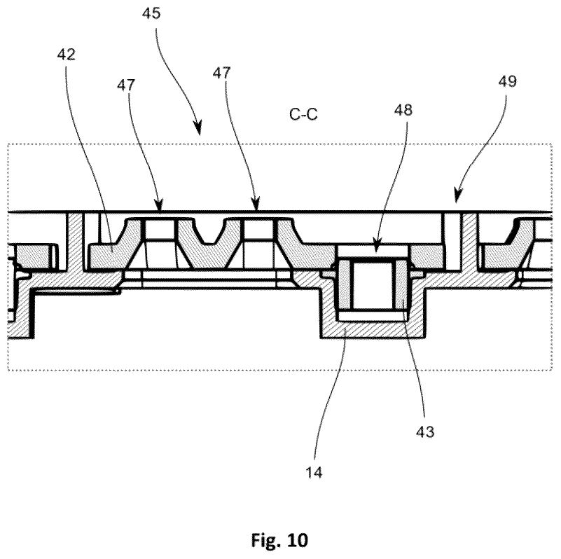

FIG. 10 shows a first embodiment of a fluid guide body in a tangentially sectional view,

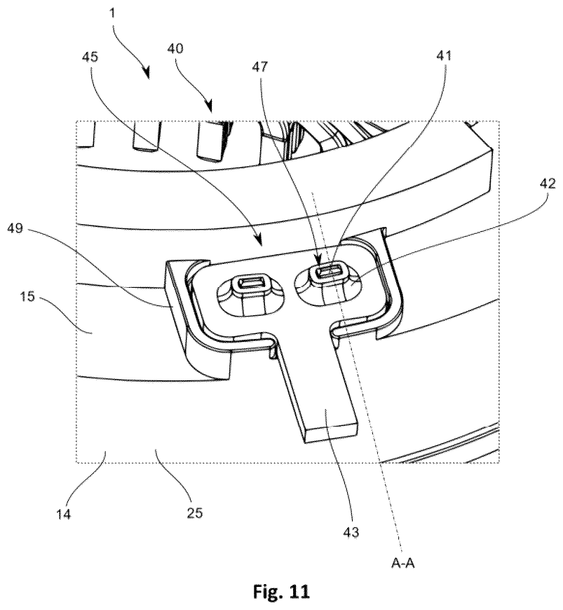

FIG. 11 shows a second embodiment of a fluid guide body in a perspective view,

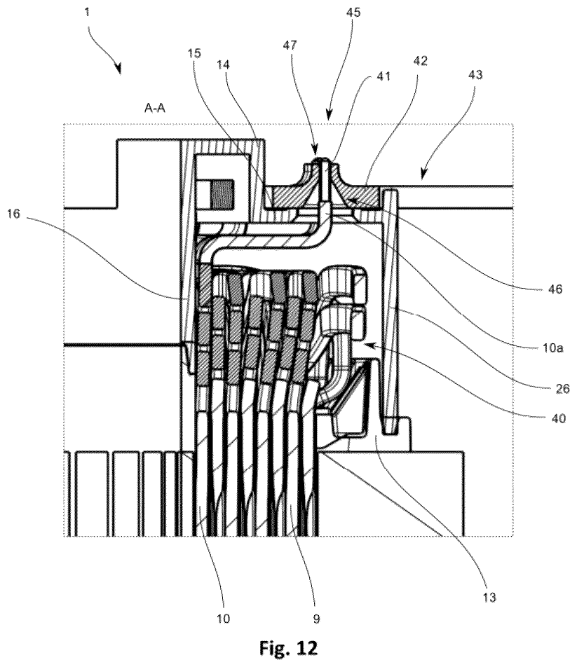

FIG. 12 shows a second embodiment of a fluid guide body in a radial sectional view,

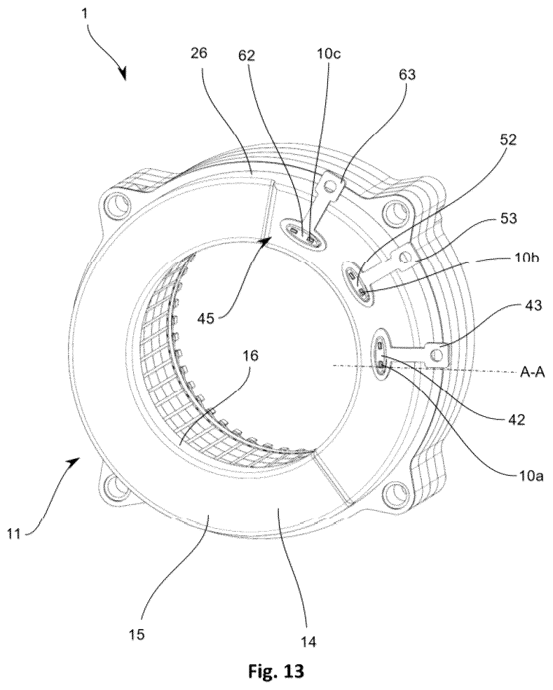

FIG. 13 shows a third embodiment of a fluid guide body in a perspective view,

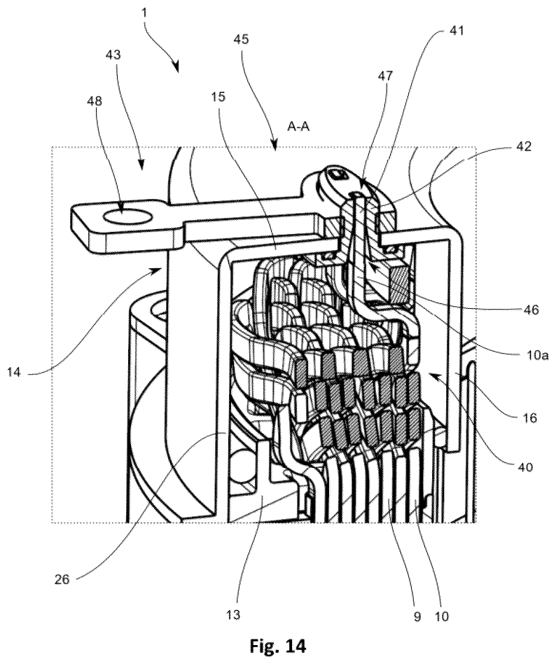

FIG. 14 shows a third embodiment of a fluid guide body in a radial sectional view,

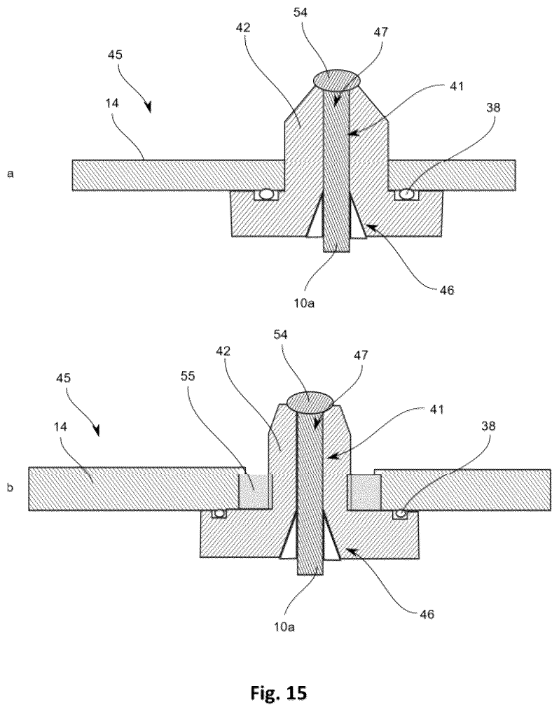

FIG. 15 shows a first and a second embodiment of a contacting means in a schematic sectional view,

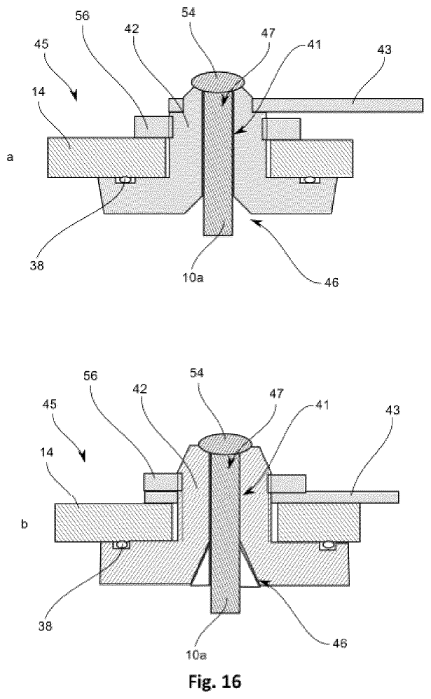

FIG. 16 shows a third and a fourth embodiment of a contacting means in a schematic sectional view,

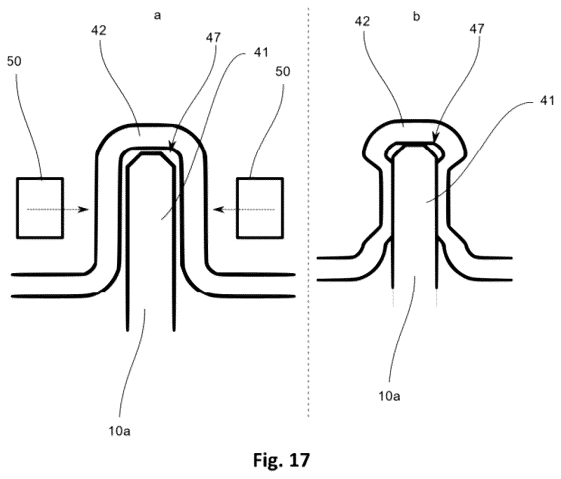

FIG. 17 shows a fifth embodiment of a contacting means in a schematic sectional view.

### DETAILED DESCRIPTION

FIGS. 1 and 2 show a stator 1 for an electric machine 2, in particular within a drive train 3 of a motor vehicle 4, as can also be seen by way of example in FIG. 1. The stator 1 is designed to be cylindrical with an inner diameter 17, in which a rotor 20 with an outer diameter 21 can be inserted, thereby forming a cylindrical air gap 22. Furthermore, the stator 1 has a plurality of stator teeth 5, which in the circumferential direction between adjacent stator teeth 5 each define a stator groove 6 that extends in the radial direction, runs in the axial direction through the stator 1 and has two groove lateral walls 7 and a groove base 8, into which an energizable winding 9 comprising a plurality of conductors 10 is inserted. In the configuration shown, the electric machine 2 is configured as an internal rotor.

As shown in FIG. 3, the stator 1 has a connection body 13 on the first end face 11 that extends at least partly away from the first end face 11 in the axial direction. This connection body 13 in turn has a first cylindrical connection section 23 extending out of the stator body of the stator 1 in the axial direction, which runs radially below a winding head of the winding 9. In the embodiment shown, the connection body 13 also has a second cylindrical connection section 24 extending axially out of the stator body of the stator 1, which runs radially above the winding head of the winding 9. As a result, the winding head is enclosed by an annular space defined by the inner cylindrical connection section 23 and the outer cylindrical connection section 24. It is possible that the connection sections 23, 24 are formed in two pieces and have no physical connection to each other, but were molded onto the stator body of the stator 1 in the same injection molding process. Here, the connection sections 23, 24 are molded from the same plastic. FIG. 3 shows an embodiment in which a connection body 13 is also formed on the end face of the stator 1 opposite the end face 11.

In the embodiment shown in FIG. 3, the connection body 13, which is formed from a plastic, is injection-molded onto the end face 11 of the stator 1, for example using a corresponding injection molding process. The stator grooves 6 with their groove lateral walls 7 and the respective groove base 8 are also at least partly injection-molded with a plastic coating, which is formed monolithically with the connection body 13.

As can be seen in particular from FIG. 4, a cooling fluid 12 can flow through the stator 1 from at least a first end face 11. To supply the cooling fluid 12, the stator 1 has a cylindrical fluid guide body 14 with an annular base 15 and an inner shell 16 extending axially out of the base 15 and an outer shell 26 extending axially out of the base 15. In this configuration, the fluid guide body 14 is reminiscent of a donut baking mold. The inner jacket 16 has an inner diameter 18 that is greater than or equal to the outer diameter 21 of the rotor 20, so that the rotor 20 can be pushed axially into the stator 1 from the end face 11. For this purpose, the inner diameter 18 of the cylindrical fluid guide body 14 can also be larger than or equal to the inner diameter 17 of the stator 1, which also enables axial insertion of the rotor 20 during assembly of the electric machine 2. The connection body 13 is molded onto and attached to the laminated core of the stator body of stator 1. The fluid guide body 14 is therefore bonded to this connection body 13 at two coaxially extending cylindrical connection sections 23, 24. The adhesive bonds between the connection body 13 and the fluid guide body 14 are oil-tight, so that there is no need for O-rings, for example. The connection body 13 and the fluid guide body 14 have centering means 35, 36 in order to position the two rotationally correctly in relation to each other, which will be explained in more detail later.

Furthermore, the fluid guide body 14 has a fluid connection 19 on its outer jacket 26 extending radially out of the outer jacket 26, via which the cooling fluid 12 can be guided through the fluid guide body 14 and via the connection body 13 into the stator grooves 6, where it can cool the winding 9 of the stator 1 accordingly. This is also known as direct groove cooling.

The inner jacket 16 and the outer jacket 26 of the fluid guide body 14 are fixed to the connection body 13 by means of an adhesive bond. For this purpose, the connection body 13 has a cylindrical inner connection section 23 on the inner diameter 17 of the stator 1, which extends axially out of the stator 1 and to which the inner jacket 16 of the fluid guide body 14 is fixed by means of the adhesive bond. Furthermore, the connection body 13 has a cylindrical outer connection section 24 extending axially out of the stator 1, to which the outer jacket 26 of the fluid guide body 14 is also fixed by means of the adhesive bond.

In FIGS. 5-6, there are three centering means 35, 36 arranged asymmetrically around the circumference, so that the fluid guide body 14 can only be mounted in a defined circumferential position relative to the connection body 13, which corresponds to a poka-yoke solution. As long as the pairwise corresponding centering means 35, 36 are not arranged in their defined circumferential joining position relative to one another, the section of the fluid guide body 14 to be bonded does not come into contact with the V-shaped connection grooves 27, 31 of the connection body 13. Thus the adhesive layer remains uninterrupted. FIG. 5 shows a possible arrangement of the slot-like centering means 36 on the connection body 13, where the slots are rotated by 105, 120 and 135° relative to one another. The solution with only one slot-like centering means 36 is also conceivable, wherein assembly using an auxiliary device is preferable in order to avoid tilting and thus contact between the sealing surfaces in the two V-grooves before rotary positioning.

The winding 9 of the stator 1 exits the stator 1 at a first end face 11, thereby forming a first cylindrical winding head 40. The cylindrical fluid guide body 14 through which the cooling fluid 12 can flow at least partly surrounds the first winding head 40, wherein at least one first conductor 10a of the winding head 40 has a first contacting section 41 that extends out of the winding head 40 in the axial direction and at least partly passes through a corresponding first electric contacting means 42, which is arranged on the fluid guide body 14 in an electrically contacting manner, wherein the first electric contacting means 42 is coupled to a first electric connection means 43 in an electrically conductive manner, by means of which an electric contacting can be established between the first conductor 10a and an inverter 44 energizing the winding 9 via an outer side 45 of the fluid guide body 14 facing away from the cooling fluid 12. This can be seen in FIGS. 7-14 using the three stator designs outlined there.

The fluid guide body 14 thus separates an internal wet area of the stator 1, which is acted upon by the cooling fluid 12, from a dry area, which is located outside the fluid guide body 14.

In these embodiments illustrated in FIGS. 7-14, a second conductor 10b of the winding head 40 has a second contacting section 51 that extends out of the winding head 40 in the axial direction and at least partly passes through a corresponding second electric contacting means 52, which is arranged on the fluid guide body 14 in an electrically contacting manner, wherein the second electric contacting means 52 is coupled to a second electric connection means 53 in an electrically conductive manner, by means of which an electric contacting can be established between the second conductor 10b and an inverter 44 energizing the winding 9 via an outer side 45 of the fluid guide body 14 facing away from the cooling fluid 12. There is also a third conductor 10c of the winding head 40 has a third contacting section 61 that extends out of the winding head 40 in the axial direction and at least partly passes through a corresponding third electric contacting means 62, which is arranged on the fluid guide body 14 in an electrically contacting manner, wherein the third electric contacting means 62 is coupled to a third electric connection means 63 in an electrically conductive manner, by means of which an electric contacting can be established between the third conductor 10c and an inverter 44 energizing the winding 9 via an outer side 45 of the fluid guide body 14 facing away from the cooling fluid 12. It will be understood that the contacting means 42,52,62 are formed of an electrically conductive material, while the fluid guide body 14 is formed of an electrically insulating material.

In the embodiments shown in FIGS. 7-14, the first electric contacting means 42, the second electric contacting means 52 and the third electric contacting means 62 each have a material connection to the fluid guide body 14, which can be designed as a bonded or overmolded connection.

The first electric contacting means 42, the second electric contacting means 52 and the third electric contacting means 62 each have a conical insertion section 46 which widens in the direction of the first winding head 40, by means of which the corresponding electrical conductor 10a, 10b, 10c is guided in the direction of the respective opening 47,57,67 when the fluid guide body 14 is placed axially on the winding head 40.

FIGS. 7-14 further show that the first electric contacting means 42 has a first opening 47 which is penetrated by the first conductor 10a and protrudes out of the first opening 47 of the first electric contacting means 42. The same applies to the second electric contacting means 52, which also has a second opening 57 which is penetrated by the second conductor 10b and protrudes out of the second opening 47 of the second electric contacting means 52. Accordingly, the third electric contacting means 62 also has a third opening 67, which is penetrated by the third conductor 10c and protrudes out of the third opening 67 of the third electric contacting means 62. The sections of the conductors 10a, 10b, 10c projecting out of the contacting means 52, 52, 62 can be welded all around so that the respective openings 47, 57, 67 are sealed fluid-tight.

FIGS. 7-14 also show that the cylindrical fluid guide body 14 has an annular base 15 and an inner shell 16 extending axially out of the base 15 and an outer shell 26 extending axially out of the base 15, wherein the inner shell 16 has an inner diameter 18 which is greater than or equal to the outer diameter 21 of the rotor 20, whereby the rotor 20 can be inserted axially into the stator 1 even after the fluid guide body 14 has already been fixed to the stator. The first electric contacting means 42, the second electric contacting means 52 and the third electric contacting means 62 are arranged in each case on the base 15 of the cylindrical fluid guide body 14.

The stators 1 shown in FIGS. 7-14 can be manufactured or assembled as follows: Initially, a cylindrical stator 1 with an inner diameter 17, in which a rotor 20 with an outer diameter 21 can be inserted, is provided, thereby forming a cylindrical air gap 22, and the stator 1 has a plurality of stator teeth 5, each stator tooth defining a respective stator groove 6 which is located between adjacent stator teeth 5 in the circumferential direction, extends in the radial direction, runs through the stator 1 in the axial direction, and comprises two groove lateral walls 7 and a groove base 8, into which an energizable winding 9 is inserted, said winding comprising a plurality of conductors 10, wherein the winding 9 exits the stator 1 at at least a first end face 11, thereby forming a first cylindrical winding head 40 and wherein a cooling fluid 12 can flow through the stator 1 from the first end face 11, wherein at least a first conductor 10a of the first winding head 40 has a first contacting section 41 that extends out of the winding head 40 in the axial direction.

Subsequently, a cylindrical fluid guide body 14 can be provided, through which the cooling fluid 12 can flow, wherein the first winding head 40 can be at least partly surrounded by the fluid guide body 14. A first electric contacting means 42 is then arranged on the fluid guide body 14, through which the first contacting section 41 of the first electrical conductor 10a can at least partly pass in an electrically contacting manner. Finally, the fluid guide body 14 can then be arranged on the first winding head 40, thereby forming the electric contacting of the first contacting section 41 with the first electric contacting means 42.

In this way, a fluid guide body 14 is then initially provided, in which a first electric contacting means 42 arranged on the fluid guide body 14 can be electrically contacted at least partly by a first conductor 10a of the winding head 40 and is coupled to a first electrical connection means 43 in an electrically conductive manner, by means of which an electric contacting can be established between the first conductor 10a and an inverter 44 energizing the winding 9 via an outer side 45 of the fluid guide body 14 facing away from the cooling fluid 12. In this way, a structural unit comprising a fluid guide body 14 and a power supply connection can be formed between the winding head 40 and an inverter 44, which simplifies assembly accordingly.

The three different embodiments of the fluid guide bodies 14 shown in FIGS. 7-14 are briefly described below.

FIGS. 7-10 show a first embodiment of a fluid guide body 14. Here, three identically designed contacting means 42, 52, 62 are each inserted in a trough 49 formed in the base 15 of the fluid guide body 14. The contacting means 42, 52, 62 each have a connection means 43, 53, 63 in the form of an internal thread which is monolithically formed with the contacting means 43, 53, 63 and which extends axially in the direction of the winding head 40 and thus does not project axially beyond the contacting means 42, 52, 62. As can also be seen in FIG. 10, the internal thread can also be formed on a separate sleeve pressed with a contacting means 42, 52, 62, which then forms the corresponding connection means 43, 53, 63. Contact can made here, for example, by screwing in a screw, which can then be used to fix an electrical conductor to the inverter 44 on the connection means 43, 53, 63.

FIGS. 11-12 show a second embodiment of a fluid guide body 14. A contacting means 42 is also accommodated in a trough 49 of the fluid guide body 14 and bonded or overmolded to it. The connection means 53 is designed here as a busbar extending out of the contacting means 42, to which, for example, a cable lug with an electrical conductor to the inverter 44 can be plugged. The connection means 53 and the contacting means 42 are formed monolithically.

FIGS. 13-14 show a third alternative embodiment of a fluid guide body 14. Here, the connection means 43 is designed as a component separate from the contacting means 42, which is attached axially to the contacting means 42 and has an opening 48, by means of which a connection can be made to an inverter. The opening 48 can then protrude radially beyond the stator 1, which is clearly illustrated in FIG. 13.

FIGS. 15-17 show various embodiments of a contacting means 42 and its connection to the fluid guide body 14 and an electrical conductor 10.

The embodiment shown in image a of FIG. 15 shows a hat-shaped contacting means 42 that is pressed into a corresponding opening of the fluid guide body 14 and protrudes from the outside 45 of the fluid guide body 14. On the side of the fluid guide body 14 facing away from the outer side 45, the hat-shaped contacting means 42 abuts with a collar in which a circumferential groove is formed for receiving a seal 38, which seals the contacting means 42 with respect to the fluid guide body. The opening 47 of the contacting means 42, through which the electrical conductor 10a of the winding head 40 passes, is sealed fluid-tight by a welding bead 54. Image b of FIG. 15 shows an embodiment in which a threaded sleeve 55 is pressed into the corresponding opening of the fluid guide body 14. The threaded sleeve 55 has an internal thread into which the hat-shaped contacting means 42 is screwed via a corresponding external thread.

In the embodiment shown in image a of FIG. 16, the contacting means 42 is locked against the fluid guide body 14 via a nut 56. For this purpose, the hat-shaped contacting means 42 has an external thread onto which the nut 56 can be screwed. The connection means 43 is pressed onto the part of the contacting means 42 projecting from the fluid guide body 14. As shown in image b of FIG. 16, the connection means 53 can also be fixed to the fluid guide body 14 by the nut 56.

In addition to the welded connections between the contacting means 42 and the electrical conductor 10 shown in FIGS. 17-16, it is also possible for the contacting means 42 to be arranged to make electrical contact with the conductor 10 by a mechanical deformation. For this purpose, in a first manufacturing step (Figure a), the contacting means 42 can initially grip around the electrical conductor 10 in a pot-like manner with play and, in a subsequent deforming step (Figure b), be pressed or caulked onto the electrical conductor 10 in a circumferentially closed manner by a tool 50.

The disclosure is not limited to the embodiments shown in the figures. The above description is therefore not to be regarded as limiting, but rather as illustrative. The following claims are to be understood as meaning that a stated feature is present in at least one embodiment of the disclosure. This does not exclude the presence of further features. Where the claims and the above description define “first” and “second” features, this designation serves to distinguish between two features of the same type without defining an order of precedence.

### LIST OF REFERENCE SIGNS

1 Stator
2 Electric machine
3 Drive train
4 Motor vehicle
5 Stator teeth
6 Stator groove
7 Groove lateral walls
8 Groove base
9 Winding
10 Conductor
11 End face
12 Cooling fluid
13 Connection body
14 Fluid guide body
15 Base
16 Inner jacket
17 Inner diameter
18 Inner diameter
19 Fluid connection
20 Rotor
21 Outer diameter
22 Air gap
23 Connection section
24 Connection section
26 Outer jacket
27 Connection groove
31 Connection groove
35 Centering means
36 Centering means
38 Seal
40 Winding head
41 Contacting section
42 Contacting means
43 Connection means
44 Inverter
45 Outer side
46 Insertion section
47 Opening
48 Opening
49 Trough
50 Tool
51 Contacting section
52 Contacting means
53 Connection means
54 Welding bead
55 Threaded sleeve
56 Nut
57 Opening
61 Contacting section
62 Contacting means
63 Connection means
67 Opening

1. A stator for an electric machine comprising:
a cylindrical ring with an inner diameter, in which a rotor with an outer diameter can be inserted, thereby forming a cylindrical air gap;
a plurality of stator teeth, each stator tooth defining a respective stator groove which is located between adjacent stator teeth in the circumferential direction, extends in the radial direction, runs through the stator in the axial direction, and comprises two groove lateral walls and a groove base, into which an energizable winding is inserted, the winding comprising a plurality of conductors, wherein the winding exits the stator at at least a first end face, thereby forming a first cylindrical winding head and wherein a cooling fluid flows through the stator from the first end face, wherein the stator has a cylindrical fluid guide body through which the cooling fluid flows and which at least partly surrounds the first winding head, wherein at least a first conductor of the winding head has a first contacting section that extends out of the winding head in the axial direction and at least partly passes through a corresponding first electric contacting means, which is arranged on the fluid guide body in an electrically contacting manner, wherein the first electric contacting means is coupled to a first electric connection means in an electrically conductive manner, by means of which an electric contact is established between the first conductor and an inverter energizing the winding via an outer side of the fluid guide body facing away from the cooling fluid.

2. The stator according to claim 1, wherein a second conductor of the winding head has a second contacting section that extends out of the winding head in the axial direction and at least partly passes through a corresponding second electric contacting means, which is arranged on the fluid guide body in an electrically contacting manner, wherein the second electric contacting means is coupled to a second electric connection means in an electrically conductive manner, by means of which an electric contacting is established between the second conductor and an inverter energizing the winding via an outer side of the fluid guide body facing away from the cooling fluid and/or a third conductor of the winding head has a third contacting section that extends out of the winding head in the axial direction and at least partly passes through a corresponding third electric contacting means, which is arranged on the fluid guide body in an electrically contacting manner, wherein the third electric contacting means is coupled to a third electric connection means in an electrically conductive manner, by means of which an electric contacting is established between the third conductor and an inverter energizing the winding via an outer side of the fluid guide body facing away from the cooling fluid.

3. The stator according to claim 2, wherein at least one of the first electric contacting means, the second electric contacting means, the third electric contacting means has a material connection with the fluid guide body.

4. The stator according to claim 2, wherein at least one of the first electric contacting means, the second electric contacting means, or the third electric contacting means has a conical insertion section which widens in the direction of the first winding head.

5. The stator according to claim 2, wherein the first electric contacting means has a first opening which is penetrated by the first conductor and protrudes from the first opening of the first electric contacting means and/or the second electric contacting means has a second opening which is penetrated by the second conductor and protrudes from the second opening of the second electric contacting means and/or the third electric contacting means has a third opening which is penetrated by the third conductor and protrudes out of the third opening of the third electric contacting means.

6. The stator according to claim 1, wherein the cylindrical fluid guide body has an annular base and an inner jacket extending axially out of the base and an outer jacket extending axially out of the base, wherein the inner jacket has an inner diameter which is greater than or equal to the outer diameter of the rotor.

7. The stator according to claim 6, wherein at least one of the first electric contacting means, the second electric contacting means, the third electric contacting means is arranged on the base of the cylindrical fluid guide body.

8. A method for producing a stator for an electric machine, comprising:
providing a cylindrical stator with an inner diameter, in which a rotor with an outer diameter can be inserted, thereby forming a cylindrical air gap, and the stator has a plurality of stator teeth, each stator tooth defining a respective stator groove which is located between adjacent stator teeth in the circumferential direction, extends in the radial direction, runs through the stator in the axial direction, and comprises two groove lateral walls and a groove base, into which an energizable winding is inserted, said winding comprising a plurality of conductors, wherein the winding exits the stator at at least a first end face, thereby forming a first cylindrical winding head and wherein a cooling fluid can flow through the stator from the first end face, wherein at least a first conductor of the first winding head has a first contacting section that extends out of the winding head in the axial direction;
providing a cylindrical fluid guide body through which the cooling fluid can flow, wherein the first winding head can be at least partly surrounded by the fluid guide body;
arranging a first electric contacting means on the fluid guide body, through which the first contacting section of the first electrical conductor can at least partly pass in an electrically contacting manner; and
arranging the fluid guide body on the first winding head, thereby forming the electric contacting of the first contacting section with the first electric contacting means.

9. A fluid guide body for flowing cooling fluid for the stator of the electric machine, according to claim 1, wherein the fluid guide body comprises:
a first electric contacting means arranged on the fluid guide body and electrically contacted at least partly by a first conductor of the winding head and is coupled to a first electric connection means in an electrically conductive manner, by means of which an electric contacting can be established between the first conductor and an inverter energizing the winding via an outer side of the fluid guide body facing away from the cooling fluid,
wherein a shape of the fluid guide body is cylindrical.

10. An electric machine wherein the electric machine comprises a stator according to claim 1.

11. A drive train comprising:
an electric machine, the electric machine including a stator and a rotor, wherein the stator comprises
a cylindrical ring with an inner diameter, wherein a rotor with an outer diameter is inserted into the cylindrical ring to form a cylindrical air gap; and
a plurality of stator teeth, each stator tooth defining a respective stator groove located between adjacent stator teeth in the circumferential direction, extends in the radial direction, runs through the stator in the axial direction, and comprises two groove lateral walls and a groove base, wherein an energizable winding is inserted into a respective stator groove, the winding comprising a plurality of conductors, wherein the winding exits the stator at a first end face and forms a first cylindrical winding head, wherein a cooling fluid flows through the stator from the first end face, wherein the stator has a cylindrical fluid guide body through which the cooling fluid flows and which at least partly surrounds the first winding head, wherein at least a first conductor of the winding head has a first contacting section that extends out of the winding head in the axial direction and at least partly passes through a corresponding first electric contacting means arranged on the fluid guide body in an electrically contacting manner, wherein the first electric contacting means is coupled to a first electric connection means in an electrically conductive manner, by means of which an electric contact is established between the first conductor and an inverter energizing the winding via an outer side of the fluid guide body facing away from the cooling fluid.

12. The drive train according to claim 11, wherein a second conductor of the winding head has a second contacting section that extends out of the winding head in the axial direction and at least partly passes through a corresponding second electric contacting means, which is arranged on the fluid guide body in an electrically contacting manner, wherein the second electric contacting means is coupled to a second electric connection means in an electrically conductive manner, by means of which an electric contacting is established between the second conductor and an inverter energizing the winding via an outer side of the fluid guide body facing away from the cooling fluid and/or a third conductor of the winding head has a third contacting section that extends out of the winding head in the axial direction and at least partly passes through a corresponding third electric contacting means, which is arranged on the fluid guide body in an electrically contacting manner, wherein the third electric contacting means is coupled to a third electric connection means in an electrically conductive manner, by means of which an electric contacting is established between the third conductor and an inverter energizing the winding via an outer side of the fluid guide body facing away from the cooling fluid.

13. The drive train according to claim 12, wherein at least one of the first electric contacting means, the second electric contacting means, or the third electric contacting means has a material connection with the fluid guide body.

14. The drive train according to claim 12, wherein at least one of the first electric contacting means, the second electric contacting means, or the third electric contacting means has a conical insertion section which widens in the direction of the first winding head.

15. The drive train according to claim 12, wherein the first electric contacting means has a first opening penetrated by the first conductor and protrudes from the first opening of the first electric contacting means and/or the second electric contacting means has a second opening penetrated by the second conductor and protrudes from the second opening of the second electric contacting means and/or the third electric contacting means has a third opening penetrated by the third conductor and protrudes out of the third opening of the third electric contacting means.

16. The drive train according to claim 11, wherein the cylindrical fluid guide body has an annular base and an inner jacket extending axially out of the base and an outer jacket extending axially out of the base, wherein the inner jacket has an inner diameter which is greater than or equal to the outer diameter of the rotor.

17. The drive train according to claim 12, wherein at least one of the first electric contacting means, the second electric contacting means, or the third electric contacting means is arranged on the base of the cylindrical fluid guide body.
